(19) United States
(12) Patent Application Publication
(10) Pub. No.: US 2025/0309336 A1
(43) Pub. Date: Oct. 2, 2025

(54) COMPOSITE POLYMER ELECTROLYTE AND METHOD OF MAKING THE SAME

(71) Applicant: Purdue Research Foundation, West Lafayette, IN (US)

(72) Inventors: Esteban E. Marinero-Caceres, West Lafayette, IN (US); Sebastian Ignacio Calderon Cazorla, Pittsburgh, PA (US); Juan Carlos Verduzco Gastelum, West Lafayette, IN (US); Gavin David Bidna, West Lafayette, IN (US)

(21) Appl. No.: 19/095,504

(22) Filed: Mar. 31, 2025

Related U.S. Application Data
(60) Provisional application No. 63/572,661, filed on Apr. 1, 2024.

(51) Int. Cl. H01M 10/056; H01M 10/0525

(52) U.S. Cl. CPC H01M 10/056; H01M 10/0525; H01M 2300/0071; H01M 2300/0082; H01M 2300/0091

(57) ABSTRACT

Composite polymer electrolytes that include a polymer material, an anionic salt, high entropy oxide nanoparticles, and surface activated nanoparticles. The high entropy oxide nanoparticles and the surface activated nanoparticles are homogeneously dispersed in a polymer matrix formed by the polymer material and the anionic salt.

### CROSS-REFERENCE TO RELATED APPLICATIONS

This application claims the benefit of U.S. Provisional Application No. 63/572,661 filed Apr. 1, 2024, the contents of which are incorporated herein by reference.

### BACKGROUND OF THE INVENTION

The invention generally relates to solid-state batteries including composite polymer electrolytes and associated methods for making composite polymer electrolytes.

The development of advanced energy storage technologies is an important component of an electrified future. Electrochemical storage cells, such as batteries, are typically used for energy storage. Lithium-ion batteries (LIBs) are used for many different electrochemical energy storage needs. Commercially available LIBs typically use ion intercalation reactions in which lithium ions reversibly travel between a cathode and anode through a liquid electrolyte (LE). However, liquid electrolytes are often combustible, cannot inhibit lithium dendrites, and/or possess a limited electrochemical window of oxidative and reductive stability. Subsequently, undesirable reactions often occur over the lifespan of a LE LIB until the onset of thermal runaway and have potential fire and/or toxicity hazards. In addition to safety issues, conventional LE LIBs may soon reach a point of diminishing returns in energy density improvements with current materials.

Solid-state batteries (SSBs) are expected to become the next generation of rechargeable batteries. SSBs typically have solid electrodes and a solid electrolyte rather than a liquid or polymer gel electrolyte in which the flammable liquid electrolyte is replaced by a solid-state electrolyte (SSE) ion conductor. The electrification of transportation, advances in portable and wearable devices and grid-scale energy storage require energy storage devices affording higher energy density, improved safety, and faster charging capabilities than current Li-ion batteries. SSE materials can be chosen from a wide range of ionic conductors that include ceramics, polymers, glasses, and composite materials. The chemical, electrochemical, thermal, and mechanical properties of an SSE can be selected to enable new electro chemistries (S, O₂), for compatibility with metal anodes (e.g., Li, Na, Ca, K), to enhance ion transport (fast charging) and efficiency, and to eliminate dendrite formation (safety and reliability).

Composite polymer electrolytes (CPEs) are candidates for use as electrolyte materials in SSBs. CPEs containing surface-activated nanomaterials such as nanoparticles of a lithium garnet-oxide material (sometimes referred to as garnet-type or simply garnet) embedded into a polymer-anion salt matrix have been reported to combine attributes of their constituent materials, for example, the high ionic conductivity (IC), chemical and electrochemical stability, and mechanical strength of garnets, and the low cost, flexibility, and stability against Li metal of polymers. As a particular example, adding Li₇La₃Zr₂O₁₂ (LLZO) garnet nanoparticles, aliovalent-substituted at the Zr and Li sites, to poly (ethylene oxide) (PEO): salt systems have been reported to significantly increase the room temperature ionic conductivity of PEO: salt matrixes from 10⁻⁶ S/cm to values of about 5×10⁻⁴ S/cm. However, such ionic conductivities are still lower than those of liquid electrolytes (about 10⁻³ to 10⁻² S/cm). Furthermore, the fraction of the total ion current carried in CPEs by the Li⁺ ions (cations), known as the transference number (t_{Li+}), is lower than unity (typically 0.3 to 0.4) hindering fast transport and Coulombic efficiency. Efforts to improve ionic conductivity in CPEs have focused on changing properties of filler particles in CPEs, such as particle size, surface chemistry, and particle ionic conductivity. Ionic conductivity depends also on the amount of filler particles added to the polymer matrix and on the ratio of polymer to anion salt. Particle percent weight loads in the range of 10% to 52% have been reported. Ideally, the filler weight load amount is as small as possible to retain the mechanical flexibility of the CPEs and lower their fabrication cost.

Ion transport in CPEs is ascribed to a chain-hopping mechanism of the Li⁺ cations that is driven by segmental motions of polymer chains in CPEs. In polymer matrixes complexed with dissociated salts, ether-oxygen units dissociate the Li salts and coordinate with the resulting free Li⁺ cations. The Li⁺ cations interact electrostatically with the polymer ether-oxygen groups and reside at these sites until the vibrational motions of the polymer overcome the binding energy of the cations, thereby facilitating chain-hopping and macroscopic ion transport. The amorphous regions of polymers have higher degrees of freedom and therefore contribute more to cation transport. Embedding ionically conducting fillers into polymers increments (increases) the fraction of amorphous regions and the amount of Lewis acid centers present at the surface of the filler particles. These compete with the Li⁺ cation for coordination with the anion, thus increasing the amount of free Li⁺ cations available for conduction and further boosting the ionic conductivity. Nevertheless, ion transport in CPEs is fundamentally limited by the segmental motions of the polymer and cannot be improved unless the electrostatic interactions between the cations and the polymer matrix can be modified.

Therefore, it would be desirable if electrostatic interactions of Li⁺ cations were reduced to lower the binding energy between the Li⁺ cations and the ether oxygen groups of the polymer chain to render ion transport in polymer matrices independent from polymer segmental motions with concomitant increases of ionic conductivity and similar to that of liquid electrolytes. Additionally, it would be desirable to immobilize the movement of large anion salts to eliminate diffusion competition between anions and cations that yield undesirable concentrations and polarization gradients that are deleterious to cation conductivity and cation transference numbers.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, composite polymer electrolytes and associated methods for making composite polymer electrolytes.

According to a nonlimiting aspect, a composite polymer electrolyte includes a polymer material, an anionic salt, high entropy oxide (HEO) nanoparticles, and surface activated nanoparticles, wherein the high entropy oxide nanoparticles and the surface activated nanoparticles are homogeneously dispersed in a polymer matrix formed by the polymer material.

According to another nonlimiting aspect, a method of making a composite polymer electrolyte includes combining a polymer material, an anionic salt, high entropy oxide nanoparticles, and surface activated nanoparticles to form a composite polymer electrolyte in which the high entropy oxide nanoparticles and the surface activated nanoparticles are homogeneously dispersed in a polymer matrix formed by the polymer material.

Technical aspects of composite polymer electrolytes and methods having features as described above preferably include the ability to promote the mechanical and electrostatic properties, Lewis/acid base interactions, polymer morphology and amorphous fraction of a composite polymer electrolyte to attain ionic conductivity values similar to those of liquid electrolytes and cation (Li⁺ ion) transference numbers approaching unity (1.0), for example, exceeding 0.4.

These and other aspects, arrangements, features, and/or technical effects will be appreciated from the following detailed description.

### BRIEF DESCRIPTION OF THE DRAWINGS

FIG. 1 shows a graphical process diagram representing a reaction for synthesizing high entropy oxide (HEO) ceramic alloy powders according to a nonlimiting aspect of the invention.

FIG. 2. Contains graphs representing data obtained from X-ray diffraction (XRD) scans of HEO ceramic alloys synthesized with the process of FIG. 1. A single rock salt phase is evident in the HEOs.

FIG. 3 shows a graphical process diagram representing synthesis of Bi-doped LiLaZrO (LLZO) powders according to a nonlimiting aspect of the invention.

FIG. 4 shows a graphical process diagram representing synthesis of a composite polymer electrolyte (CPE) containing HEO nanoparticles and Bi-doped LLZO nanoparticles as fillers of the CPE according to nonlimiting aspects of the invention.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

According to preferred but nonlimiting aspects of the disclosure, a solid-state electrolyte material for Li-ion, Li-metal and metal-anode batteries is disclosed including a polymer-anion salt matrix, wherein the mechanical, structural, ionic conductivity and the ion transference number may be synergistically controlled by the incorporation of at least two different types of nanoparticle fillers, namely high entropy oxide (HEO) ceramic alloys (sometimes referred to herein as HEO or HEOs for convenience) with very large dielectric constants, and surface-activated nanomaterials. In investigations leading to the invention, HEOs were determined to control the electrostatic interactions of cations and anions with a polymer chain and Lewis acid/base interactions with Li salts to promote anion salt dissociation, and the surface-activated nanoparticles (aliovalent-substituted LiLaZrO garnet-oxide powders were used in investigations leading to the present invention) were determined to form interconnected high ionic conductivity amorphous channels in the CPE.

HEOs are a class of ceramic alloy materials that exhibit thermodynamic stability as a result of having a high level of disorder in the arrangement of their components. HEOs have been found to exhibit enhanced mechanical, thermal, ionic conductivity and dielectric properties that make them promising in structural and functional applications.

LiLaZrO garnet-oxide materials (Li₇La₃Zr₂O₁₂, also known as lithium lanthanum zirconate or lithium lanthanum zirconium oxide (LLZO)) are surface-activated nanomaterials that exhibit superionic conductivity whose magnitude depends on the nature and amount of the substituent element, and for the case of solid ceramic conductors, on the degree of grain sintering and densification. To attain high ionic conductivity, LLZO materials must be stabilized in a cubic phase that traditionally has been accomplished through elevated temperature annealing (greater than 1000° C.) of precursor powders prepared by ball milling of oxide precursors. During investigations leading to the present invention, it was determined that employing sol-gel methods and aliovalent substitution of zirconium (Zr) by bismuth (Bi) in LiLaZrO (Li₇₋ₓLa₃Zr₂₋ₓBiₓO₁₂, sometimes referred to herein as Bi-doped LLZO, Bi-doped LiLaZrO, LiLaZrBiO, or more generally aliovalent-substituted LiLaZrO) could be used to yield a garnet-oxide material in which the desired cubic phase could be formed at temperatures at and below about 700° C. Furthermore, the ionic conductivities of the Bi-doped LiLaZrO materials were determined to be increased by their bismuth contents.

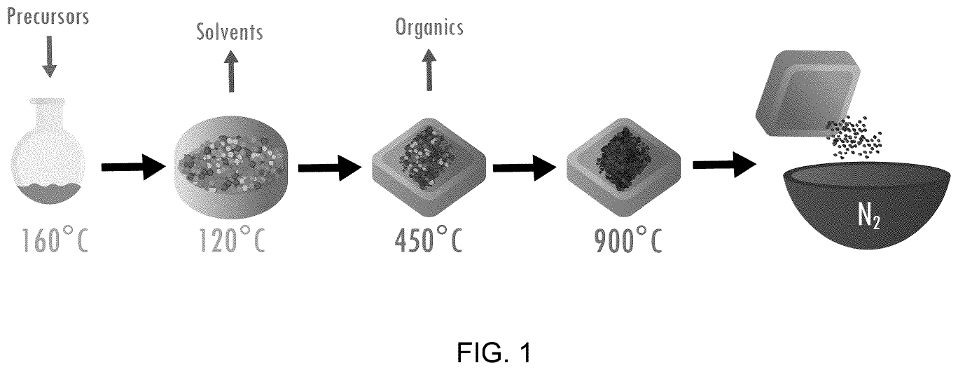

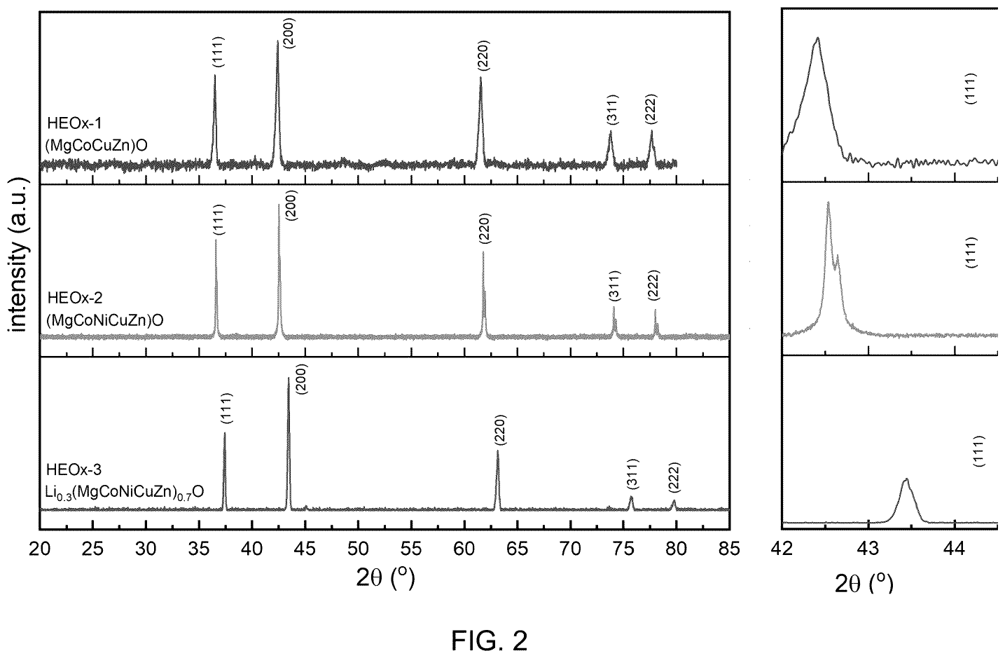

FIG. 1 depicts a diagram representing a synthesis process utilized in the investigations to produce HEO powders for use as a filler for the solid-state electrolyte material. As a nonlimiting aspect of this disclosure, (MgCoNiCuZn)₁₋ₓ—LiₓO HEOs were synthesized using a sol-gel process involving the chelation of metal ions by citric acid and polymerization of the citric acid complexes with ethylene glycol (EG). A solution with an equal concentration of 0.0625M was mixed from magnesium nitrate hexahydrate (Mg(NO₃)₂·6H₂O, 98% purity, Sigma-Aldrich), cobalt(II) nitrate hexahydrate (Co(NO₃)₂·6H₂O, >98% purity, Sigma-Adrich), copper(II) nitrate trihydrate (Cu(NO₃)₂·3H₂O, 99% purity, Sigma-Aldrich), zinc nitrate hexahydrate (Zn(NO₃)₂·6H₂O, 98% purity, Sigma-Aldrich), nickel nitrate hexahydrate (Ni(NO₃)₂·6H₂O, 99.999% purity, Sigma-Aldrich), and nanopure water. A separate solution containing 0.2M citric acid and 0.2M ethylene glycol was prepared by mixing the citric acid, ethylene glycol, and nanopure water. These two solutions were mixed in a 1 to 1 ratio with a magnetic stirrer in a silicone bath heated to 160° C. until a gel formed. This gel was dried at 120° C. for 24 hours and then calcined at 450° C. for four hours to remove the organic component of the mixture. After manually grinding the powder, it was heated to 900° C. for one hour and then quenched in liquid nitrogen. X-ray diffraction (XRD; Bruker D8 focus, Cu K-α) and inductively coupled plasma mass spectrometry confirmed the presence of a single rock salt phase and nominal composition, respectively, of the HEO powders. FIG. 2 represents the graphical depiction of XRD scans for three HEO powders with different stoichiometry, evidencing the formation of the single rock salt phase in each HEO.

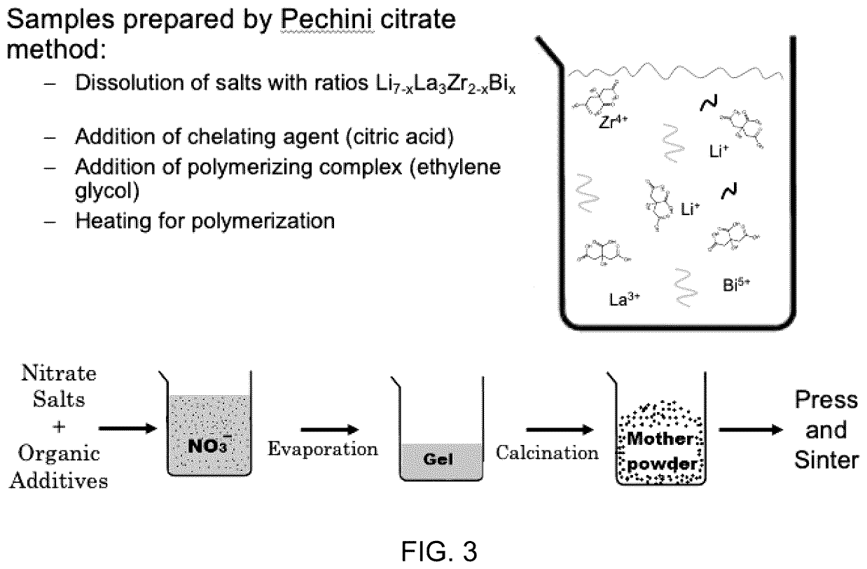

FIG. 3 depicts a diagram representing a synthesis process utilized in the investigations to produce Bi-doped LLZO powders for use as a filler for the solid-state electrolyte material. As a nonlimiting aspect of this disclosure, Bi-doped LLZO powders of the nominal composition Li₇₋ₓLa₃Zr₂₋ₓBiₓO₁₂ were fabricated from nitrate precursors by the citrate-gel Pechini method using a polymerized complex intermediary. Specific Bi-doped LLZO compositions produced included Li₆La₃ZrBiO₁₂, Li_{6.25}La₃Zr_{1.25}Bi_{0.75}O₁₂, and Li_{6.25}La_{2.8}Zr_{1.25}Nd_{0.2}Bi_{0.75}O₁₂. In this process, reagent grade chemicals of LiNO₃ (99.0% Sigma-Aldrich), La(NO₃)₃·6H2O (99.9% Alfa Aesar), ZrO(NO₃)₂·xH2O (99% Sigma-Aldrich), and Bi(NO₃)₃·5H2O (98% Alfa Aesar) were dissolved along with citric acid as a chelating agent into dilute nitric acid. After complete dissolution of the solids, ethylene glycol was added as a complexing agent of the polymerized mixture through polyesterfication of the chelated ionic compounds. A metallic ion to organic ratio of 38:62 was used to incorporate all the metal cations into the complex. To avoid auto-ignition of the resulting polymer upon pyrolysis, a citric acid to ethylene glycol ratio of 40:60 was used. The resulting solution was stirred at 70° C. until a thick transparent gel was formed, which was then heated at 120° C. to evaporate any remaining solvents, leaving behind a brown, rubbery solid. The polymerized complexes underwent a calcination step at temperatures of 600° C. and 700° C. for ten hours in an MgO crucible, which resulted in the formation of Bi-doped LLZO powder whose particles had the desired cubic phase. X-ray diffraction was employed to determine the role of Bi in the formation of the cubic phase and in the phase stability as a function of a garnet-oxide composition.

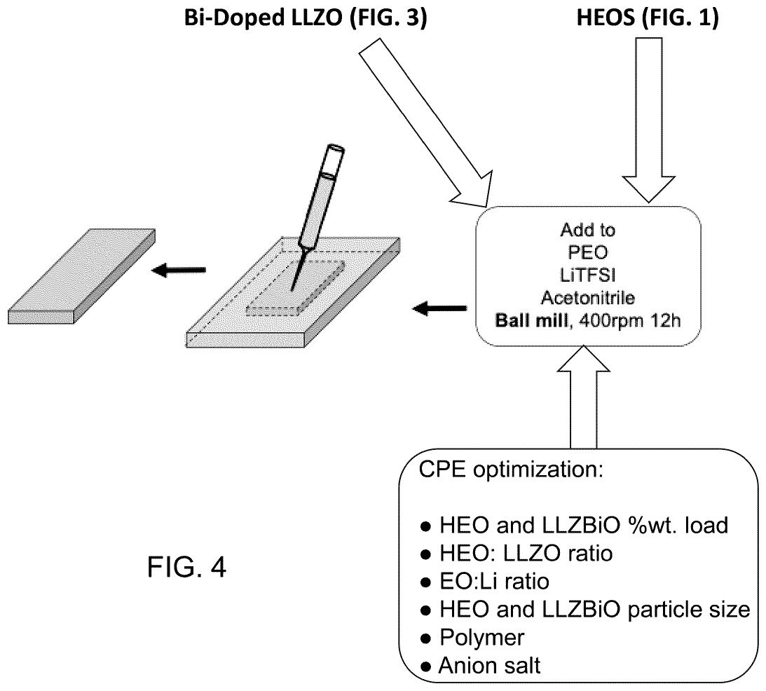

FIG. 4 depicts a diagram representing a synthesis process utilized in the investigations to produce CPEs for the solid-state electrolyte material. As indicated, the CPEs were produced with HEO powders synthesized by the process represented in FIG. 1 and Bi-doped LLZO powders synthesized by the process represented in FIG. 3. The HEO and Bi-doped LLZO powders were mixed with PEO (MW=100,000; Sigma-Aldrich) as the polymer, lithium bis(trifluoromethanesulfonyl)imide (LiTFSI, Sigma-Aldrich, 99.8%) as the anion salt, and acetonitrile (ACN, Sigma-Aldrich, 99.9%) as a solvent. A PEO:Li ratio of 49:1 was selected, based on prior studies that determined a suitable ratio required to maximize ionic conductivity in PEO (MW=100,000)-Bi-doped LLZO composite solid membranes. ACN was mixed at a 2.5:1 liquid-to-solid ratio to form a slurry. The slurry was wet ball-milled for twelve hours at 400 rpm with a Fritsch Pulverisette 6 apparatus to promote a homogeneous nanoparticle distribution across the volume of the material, reduce the particle sizes of the HEOS and Bi-doped LLZO powders to the nanometer scale, and yield homogeneous nanoparticle distributions across the volume of the slurry. The Bi-doped LLZO nanoparticles were determined to have an average size of about 437 nm (d50). The slurry was then cast into a suitable mold to form films having desired physical dimensions for the flexible solid-state electrolyte membranes. All films were dried for seventy-two hours at room temperature in air to allow slow evaporation of the ACN solvent. Thereafter, the films were held in vacuum to completely remove the ACN.

Requirements for current-art CPEs to exhibit high ionic conductivity include high solubility of anion salts in the polymer, a high polymer amorphous fraction, filler particles to promote anion salt disassociation, and the generation of high ionic conductivity channels in the polymer matrix. While not wishing to be limited to any particular theory, further increases to achieve parity with liquid electrolytes are believed to require decoupling segmental motions from ion transport, immobilizing anion salt diffusion to eliminate polarization and concentration gradients. Decoupling segmental motions from ion transport in polymers is believed to achieve superionic conductivities as the segmental relaxation rate in polymers is 10³-10⁴ slower than what is needed to achieve ionic conductivities similar to that of liquid electrolytes.

According to nonlimiting aspects of the disclosure, the dielectric constant of CPEs produced as described above was determined to be increased by additions of HEO nanoparticles, whose dielectric constant (F) was extremely high (>100,000). Such large values of t permit raising the overall dielectric constant of the polymer matrix using weight loadings at very small percentages of the HEO nanoparticles, which reduces the risk of compromising the mechanical and other rheological properties of the polymer matrices of the CPEs. The HEO nanoparticle loading required to reduce the electrostatic interactions between the cations and the polymer depended on the ion charge and on the molecular structure of the polymer. The incorporation of the HEO nanoparticles is believed to enable the utilization of hitherto not employed non-ionically conducting polymers that offer amongst other, higher melting points than state-of-the art polymer materials employed in CPEs. This is possible as increasing the polymer dielectric constant makes it more likely to dissolve polar/ionic compounds such as anion salts.

HEO nanoparticles having a rock-salt structure and high dielectric constant were further concluded to enable the dissociation of Li-salts through Lewis acid-base interactions and the increase of free Li⁺ concentration. HEO nanoparticles with stoichiometry MgCoNiCuZn)1-x-LixO have been characterized to exhibit oxygen surface vacancies. These vacancies are effective in trapping anions via electrostatic interactions, anion immobilization is required to eliminate diffusion competition between cations and anions and polarization and concentration gradients that limit the Li⁺ cation transference number.

According to other nonlimiting aspects of the disclosure, the formation of high ion transport macroscopic channels in the polymer matrix is necessary to attain CPEs with high ionic conductivity and transference numbers approaching unity. The CPEs produced during the investigations achieved this objective through the addition of Bi-substituted LiLaZrO nanoparticles to the polymer matrix. By adjusting the Li-molar content in Li₇₋ₓLa₃Zr₂₋ₓBiₓO₁₂ nanoparticle fillers added to the polymer matrix was determined in the investigations to increase ionic conductivity through the formation of high ionic conductivity channels in the polymer matrix. Macroscopic interconnection of these channels was controlled by the Li-molar content of the garnet-oxide material and the particle percent weight load added to the polymer.

According to another nonlimiting aspect of the disclosure, the surface chemistry and charge of filler particles in CPEs provide molecular and electrical routes to significantly improve ionic conductivity and ion diffusivity. In the investigations, surface chemistry was manipulated and LiLaZrO filler particles were charged by modifying the Li molar content through aliovalent substitution of Zr by Bi additions. This yielded vacancies at the Li-sites, thereby modifying the properties of the filler particle surfaces. It was found that the Li-vacancy density in the garnet-oxide material promoted increased ionic conductivity in the CPEs, as well as the percent weight load amount required to attain the maximum value. Tuning the Li-molar content in Li₇₋ₓLa₃Zr₂₋ₓBiₓO₁₂ by changing the Bi content resulted in a 100× increase of the PEO:LiTFSI matrix ionic conductivity with particle percent weight load additions of only 5%. Structural characterization of the polymer matrix indicated that modifying the filler particle surface properties resulted in the formation of interconnected high ionic conductivity channels in the polymer matrix. This chemical manipulation of polymer microstructure constituted an approach to enhance ionic conductivity in CPEs.

As previously noted above, though the foregoing detailed description describes certain nonlimiting aspects of one or more particular embodiments of the invention, alternatives could be adopted by one skilled in the art. For example, the electrochemical cells, quasi-solid-state electrolytes, and their components could differ in appearance and construction from the embodiments described herein and shown in the drawings, functions of certain components of the electrochemical cells, quasi-solid-state electrolytes, and their components could be performed by components of different construction but capable of a similar (though not necessarily equivalent) function, and various materials could be used in the fabrication of the electrochemical cells, quasi-solid-state electrolytes, and/or their components. As such, and again as was previously noted, it should be understood that the invention is not necessarily limited to any particular embodiment described herein or illustrated in the drawings.

1. A composite polymer electrolyte comprising a polymer material, an anionic salt, high entropy oxide nanoparticles, and surface activated nanoparticles, the high entropy oxide nanoparticles and the surface activated nanoparticles being homogeneously dispersed in a polymer matrix formed by the polymer material and the anionic salt.

2. The composite polymer electrolyte of claim 1, wherein the surface activated nanoparticles comprise aliovalent substituted LiLaZrO nanoparticles.

3. The composite polymer electrolyte of claim 1, wherein the high entropy oxide nanoparticles comprise (MgCoNiCuZn)₁₋ₓ—LiₓO.

4. The composite polymer electrolyte of claim 1, wherein the composite polymer electrolyte has a predominant amorphous structure.

5. The composite polymer electrolyte of claim 1, wherein the anionic salt is a source of free Li.

6. The composite polymer electrolyte of claim 1, wherein the high entropy oxide nanoparticles increase the dielectric constant of the composite polymer electrolyte.

7. The composite polymer electrolyte of claim 1, wherein the surface activated nanoparticles create macroscopic ionic conductivity channels in the composite polymer electrolyte.

8. The composite polymer electrolyte of claim 1, wherein the high entropy oxide nanoparticles are contained in the composite polymer electrolyte at a percent weight load that reduces electrostatic interactions between cations and anions with polymer chains in the composite polymer electrolyte.

9. The composite polymer electrolyte of claim 1, wherein the high entropy oxide nanoparticles are contained in the composite polymer electrolyte at a percent weight load that promotes dissociation of the anionic salt and/or immobilizes the anionic salt.

10. The composite polymer electrolyte of claim 1, wherein the surface activated nanoparticles are contained in the composite polymer electrolyte at a percent weight load that increases the ionic conductivity of the composite polymer electrolyte.

11. The composite polymer electrolyte of claim 1, wherein the composite polymer electrolyte has a cation transference number of greater than 0.4.

12. The composite polymer electrolyte of claim 1, wherein the high entropy oxide nanoparticles and the surface activated nanoparticles are embedded in the polymer matrix.

13. A method of making a composite polymer electrolyte, the method comprising:
combining a polymer material, an anionic salt, high entropy oxide nanoparticles, and surface activated nanoparticles to form the composite polymer electrolyte in which the high entropy oxide nanoparticles and the surface activated nanoparticles are homogeneously dispersed in a polymer matrix formed by the polymer material and the anionic salt.

14. The method of claim 13, wherein the surface activated nanoparticles comprise aliovalent substituted LiLaZrO nanoparticles.

15. The method of claim 14, wherein the aliovalent substituted LiLaZrO nanoparticles are synthesized by a sol-gel method comprising a calcination step that yields a cubic phase in the aliovalent substituted LiLaZrO nanoparticles at a temperature at or below about 700° C.

16. The method of claim 13, wherein the high entropy oxide nanoparticles comprise (MgCoNiCuZn)₁₋ₓ—LiₓO.

17. The method of claim 13, wherein the high entropy oxide nanoparticles are contained in the composite polymer electrolyte at a percent weight load that:
reduces electrostatic interactions between cations and anions with polymer chains in the composite polymer electrolyte; and/or
promotes anionic salt dissociation; and/or
promotes immobilization of the anionic salts.

18. The method of claim 13, wherein the surface activated nanoparticles are contained in the composite polymer electrolyte at a percent weight load that increases ionic conductivity of the composite polymer electrolyte.

19. The method of claim 13, wherein the composite polymer electrolyte has a cation transference number of greater than 0.4.

20. The method of claim 13, wherein the high entropy oxide nanoparticles and the surface activated nanoparticles are embedded in the polymer matrix.
